(19) United States
(12) Patent Application Publication
(10) Pub. No.: US 2015/0019983 A1
(43) Pub. Date: Jan. 15, 2015

(54) COMPUTER-IMPLEMENTED VIRTUAL OBJECT FOR MANAGING DIGITAL CONTENT

(71) Applicant: CRACKPOT INC., Las Vegas, NV (US)

(72) Inventor: Stephen White, Las Vegas, NV (US)

(21) Appl. No.: 14/178,367

(22) Filed: Feb. 12, 2014

Related U.S. Application Data
(60) Provisional application No. 61/930,448, filed on Jan. 22, 2014.
(60) Provisional application No. 61/903,180, filed on Nov. 12, 2013.
(60) Provisional application No. 61/845,005, filed on Jul. 11, 2013.

(51) Int. Cl. G06F 3/0484; H04L 29/08; G06F 3/0481; G06F 3/0482

(52) U.S. Cl. CPC G06F 3/04842; G06F 3/0482; H04L 67/10; G06F 3/04815
USPC 715/739; 715/821

(57) ABSTRACT

A computer-implemented virtual three dimensional object for organizing a plurality of files. The virtual object is presented on a display of a user computing device, and has a plurality of delineated surfaces. A user can manipulate the virtual object to select one of the surfaces for more prominent presentation on the display. The surface may have disposed thereon a graphical element, which the user can choose to perform a predetermined task associated with at least one of the plurality of files.

### CROSS-REFERENCE TO RELATED APPLICATIONS

This application claims priority to U.S. Provisional Patent Application Ser. No. 61/930,448, filed Jan. 22, 2014, entitled “System and Methods for Delivery Information and a Platform for Same”, U.S. Provisional Patent Application Ser. No. 61/903,180, filed Nov. 12, 2013, entitled “Systems and Method for Mobile Social Network Interactions”, and U.S. Provisional Application Ser. No. 61/845,005, filed Jul. 11, 2013 entitled, “Engine, System and Method of Providing Interactive Content Delivery Management”, each of which are incorporated by reference herein as if set forth in their entireties.

The present application is also related to U.S. patent application Ser. No. ______, entitled “Multi-Dimensional Content Platform for a Network”, U.S. patent application Ser. No. ______ entitled “System and Method for Creating a Unique Media and Information Management Platform”, and U.S. patent application Ser. No. ______ entitled “An Apparatus, System and Method for a Graphical User Interface for a Multi-Dimensional Networked Content Platform”, which are all filed contemporaneously, the entireties of which are incorporated by reference herein.

### BACKGROUND

Consumer-oriented computing devices continue to proliferate in an ever-expanding variety of devices having many different form factors. Many such devices have at least a few elements in common, including a processor for executing instructions and operating on data, a long-term storage device for storing data and instructions to be executed on the processor, and a fast memory device for storing the most immediately useful data and instructions and making them available to the processor more quickly than the long-term storage device can. Many consumer devices also include a display device that can display graphical information, and an user input device, which may be combined with the display in a touch-screen display; a microphone and speaker for communications, a camera for recording images and video, and one or more radio transceivers for transmitting and receiving various electromagnetic signals over various independent and/or cooperating networks, for a plurality of communications, data, and location applications. These consumer devices generally operate using an operating system that provides an application environment in which applications run, and also provides access to various of the components in the device, such as those just mentioned. One popular approach to providing convenient access to each of a plurality of different files or applications (apps) is to provide a graphical user interface (GUI) that displays a plurality of icons, each one representing one of the files or apps. To access the corresponding file or app, the user simply selects an icon with a pointing device, or a finger on a touch-sensitive screen. If the icon represents an app, the app launches; if it represents a file, an appropriate app launches and opens the file.

The consumer devices very commonly communicate with each other and/or with other types of computers and network resources using the Internet. Often, but not necessarily, devices communicatively coupled to the Internet communicate using common protocols and sending and receiving code in an interpreted language such as Hypertext Markup Language (HTML) over a network called the World Wide Web (WWW, or “web”). HTML is basically computer code that is generated by a so-called web server application running on a server computer that provides text-based information, formatting cues, links to other electronic files, and the like, and so-called web browser applications on user devices that “interpret” the computer code, by formatting the information for presentation using the formatting cues, retrieving the linked-to files, and launching appropriate applications corresponding to the retrieved files, and presenting the whole to a user of the consumer device. A displayed collection of such code and linked files is called a “web page”. The web comprises billions of interlinked web pages and other electronic files that are accessed by hundreds of millions of people every day. The easy access to electronic information provided by the web has led to a proliferation of such information, with attendant challenges regarding organizing a plurality of web pages, linked files, and the like. One solution in the prior art is a web browser that provides a plurality of “tabs” across the top of the browser, each tab representing a different web page or the like that can be accessed and displayed by selecting the corresponding tab.

Various factors have begun to make apparent certain limitations of conventional prior-art technologies and techniques for selecting, retrieving, organizing, and presenting information and electronic files that reside on a plurality of interconnected server and client devices, and/or that are displayable or “playable” using a plurality of different apps. One factor is that user devices having physically diminutive display screens have proliferated dramatically, making the manipulation of prior art GUI elements rather difficult. Another factor is that there is no truly convenient way to gather, make accessible, and present a plurality of files that pertain to a single subject, particularly if the files correspond to different apps that are needed to access or play the files.

As such, it would be helpful to have a display mechanism that is easy to use, can easily organize and make available to a user a plurality of different files of a plurality of different types, and that can easily access and present such files and apps, whether they reside in the user device, or if some or all of the files and/or apps individually reside on one or more different server devices, each one communicatively coupled to the user device over a network such as the Internet.

### SUMMARY

A computer-implemented virtual three dimensional object for organizing and sharing a plurality of files. The virtual object is presented on a display of a user computing device, and has a plurality of delineated surfaces. A user can manipulate the virtual object to select one of the surfaces for more prominent presentation on the display. The surface may have disposed thereon a graphical element, which the user can choose to invoke a predetermined task or function associated with at least one of the plurality of files.

Additional features and advantages will be made apparent from the following detailed description that proceeds with reference to the accompanying drawings. It is to be understood that both the foregoing general description and the following detailed description are exemplary and explanatory and are intended to provide further explanation of the invention as claimed.

### DESCRIPTION OF THE DRAWINGS

The following detailed description may be best understood when taken in conjunction with the accompanying drawings, of which:

FIG. 1 is a diagram of an exemplary networked system that provides context for the described functionality;

FIG. 2 is a block diagram of an exemplary computing device;

FIGS. 3A and 3B are exemplary virtual objects in accordance with the disclosure;

FIGS. 4A, 4B, and 4C are exemplary graphical environments in which the described virtual objects may be presented;

FIGS. 5A and 5B illustrate an exemplary implementation of a virtual object in accordance with the disclosure;

FIGS. 6A and 6B illustrate another exemplary implementation of a virtual object in accordance with the disclosure;

FIGS. 7A and 7B are illustrate surfaces of exemplary virtual objects that may be configured in accordance with the disclosure;

FIGS. 8A-8H are screenshots of an exemplary system for use in setting up a virtual object in accordance with the disclosure;

FIG. 9 illustrates an exemplary system and method for use in setting up a virtual object in accordance with the disclosure;

FIG. 10 illustrates an exemplary system and method for use in sharing a virtual object in accordance with the disclosure;

FIG. 11 is a method in accordance with the disclosure.

### DETAILED DESCRIPTION

It is to be understood that the figures and descriptions provided herein may have been simplified to illustrate aspects that are relevant for a clear understanding of the herein described apparatus, systems, and methods, while eliminating, for the purpose of clarity, other aspects that may be found in typical devices, systems, and methods. Those of ordinary skill in the pertinent art may recognize that other elements and/or steps may be desirable and/or necessary to implement the devices, systems, and methods described herein. Because such elements and steps are well known in the art, and because they do not facilitate a better understanding of the present disclosure, a discussion of such elements and steps may not be provided herein. However, the present disclosure is deemed to inherently include all such elements, variations, and modifications to the described aspects that would be known to those of ordinary skill in the pertinent art.

The following description relates to a new and different user interface element and supporting mechanisms. The user interface element can be seen and manipulated on user devices having physically diminutive display screens more easily than interface elements of the prior art. The interface element also provides a more convenient way than the prior art to group together, make accessible, and present a plurality of files, such as filed that pertain to a single subject, particularly if the files correspond to different apps that are needed to access or play the files.

As such, the disclosed systems and methods provide a user with an interface element that is easy to use, can easily group together links to a collection of different files of a plurality of different types, and can easily access and present such files and apps whether they reside on the user device, or whether some or all of the files and/or apps individually reside on one or more different server devices, each one communicatively coupled to the user device over a network such as the Internet. The disclosed systems and methods make the links to files easily available to the user, and easily sharable with another.

The techniques described herein focus on gathering information and files to be presented as a collection via a single virtual three dimensional object displayed on a graphical display of a user device. The virtual object can be manipulated by a user using an input device to change its rotation and orientation in virtual space presented on a two dimensional display. The virtual object may have a plurality of clearly delineated surfaces, any one of which can be oriented toward the user by rotating or changing the orientation of the object. That surface can then be interacted with by the user to access one or more of the files, such as a subset of the files. The user device may be a computing user device, such as a desktop, laptop, or tablet computer, smartphone or the like, or some other device that has an appropriate graphical display device, a computing processor, a data storage device, and some sort of user input mechanism.

The techniques described herein further focus on the presentation of the virtual three dimensional object and its manipulation in space by the user interacting with various geometric features of the object, such as its surfaces edges, and corners. Controls can be used by the user to spin and/or change the orientation of the object. Alternatively, a pointing device or a finger on a touch sensitive screen may be used to interact directly with the virtual object.

While the techniques disclosed herein are described with reference to a web-based implementation, the concepts presented are equally applicable to other implementations, such as, for example, as standalone icon-like entities that appear in a display area of a GUI independently of a web browser, or within the context of a stand-alone application directed to some useful task beyond the mere display of information and files. Thus, while the descriptions herein may make reference to and be illustrated in a “web browser” and “web page” implementation, the described mechanisms are agnostic as to communication and display format, and are not intended to be limited to only environments based on the Hypertext Transfer Protocol (HTTP) and the Hypertext Markup Language (HTML).

Although not necessarily required, the described systems and methods will be in the general context of computer-executable instructions, such as program modules, being executed by a computing device. More specifically, the description may reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms or otherwise operates on data or maintains it at locations in memory, which reconfigures or otherwise alters the operation of the computing device or peripherals in a manner well understood by those skilled in the art. The data structures in which data are maintained are physical locations that have particular properties determined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, and the like. Similarly, the computing devices need not be limited to stand-alone computing devices, as the mechanisms may also be practiced in distributed computing environments where at least some tasks may be performed by remote processing devices that are communicatively coupled through a communications network. As such, in a distributed computing environment, instructions and program modules may be located in both local and remote data storage devices, and executed on both local and remote processors.

The presentation of a virtual three dimensional object on a display device as described herein includes a plurality of display elements, which may optionally be implemented as separate user interface elements. Whether such display elements are considered to be within the same virtual object or separate discrete entities, implementation of these display elements in an object-oriented environment would be well within the abilities of an ordinary artisan having the benefit of the disclosure herein.

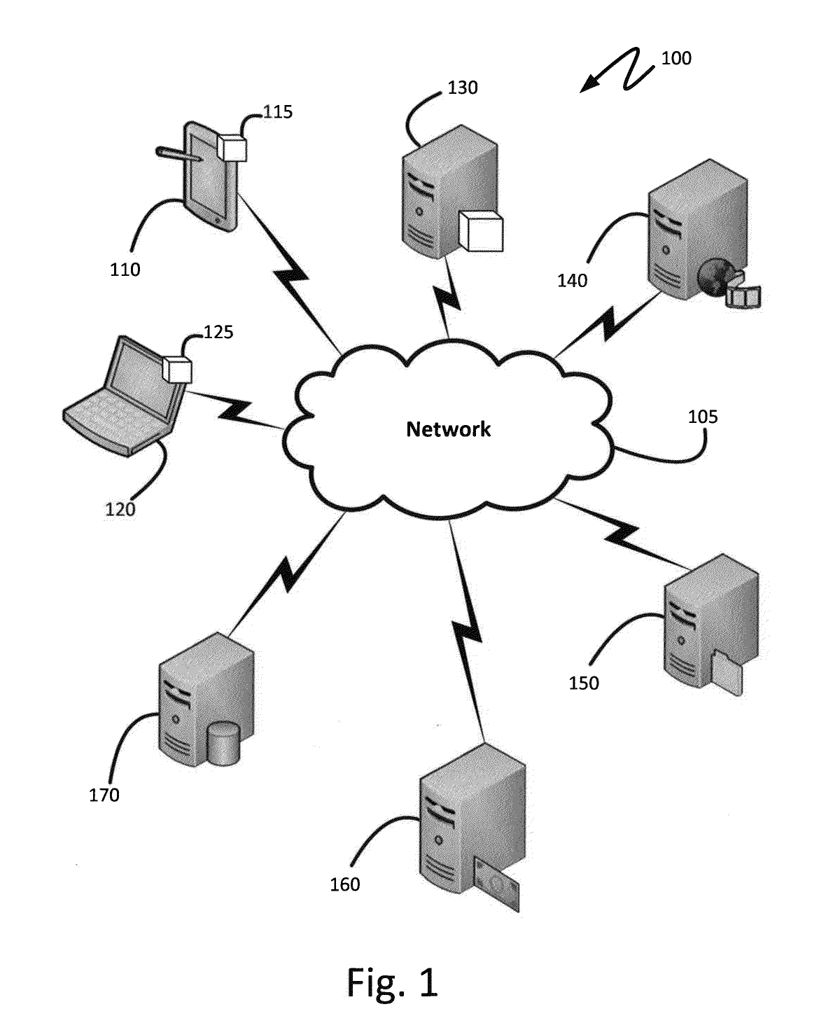

With reference to FIG. 1, an exemplary system 100 is illustrated, providing context for the descriptions below. The exemplary system 100 can operate over or include part of a network 105, with may be or interface with the Internet, although the reference to the Internet is merely an example and is not intended to limit the descriptions to Internet protocols, such as the Transmission Control Protocol (TCP), the Internet Protocol (IP), or any other Internet-specific technology. Exemplary system 100 includes a personal computing device 110 such as a tablet computer which has residing thereon a virtual object such as cube 115 as will be described, and a second personal computing device 120, such as a laptop computer which has a cube 125. Both personal computing devices are communicatively coupled to the network 105. Note that cube 125 can either be a copy of cube 115, or a different cube than 115. For convenience, in the following description the term “cube” may be used interchangeably with the term “virtual object”, and may have any shape as long as it comports with the described apparatus, systems, and methods, even if the virtual object is not in the form of a cube.

Various server computers are also communicatively coupled to the network 105, including cube server 130 as will be described, streaming media server 140, file server 150, e-commerce server 160, and database server 170. Each of the server computers can provide files and/or services to the personal computing devices. More precisely, the various files residing on, and services provided by, the server computers can be accessed and displayed by the personal computing devices over network 105. In an exemplary implementation, the server computers may be or include web servers. However, as with the reference to the Internet itself, the reference to the web and web servers is merely exemplary and is not intended to limit the descriptions to HTTP, HTML, or any other web specific technology.

Each of the user devices 110, 120, and each of the servers 130, 140, 150, 160, 170 has a unique identifier on the network, such as a uniform resource identifier (URI), a universal resource locator (URL), or other identifier that enables interaction with the corresponding device over network 105. The servers store files, each of which has an identifier that allows the corresponding file residing on the respective server to be properly identified to a user device. The user device can then interact with the file, such as by downloading or streaming the file from the server to the user device. The file identifiers may comprise different parts that may be parsed by the user device, such as a path on the server to the file indicating where within the file structure of the server the file may be found; a filename; and a file extension indicating what type of file it is. Streaming media server 140 may provide audio/video files that may be continuously received by and presented on a user device as it is being provided by the media server. File server 150 may provide access to any of various files of various types. E-commerce server 160 may provide to a user device access to data and functionality for buying and selling products or services over network 105. Database server 170 may provide a user device with access to data items, typically items of data that are organized and stored on the data server in a predetermined data structure, such as records of a table within a relational database. It is to be understood that user devices 110, 120, and servers 130, 140, 150, 160, 170 are introduced by way of illustration and not limitation, and that the herein disclosed apparatus, methods, and systems may be used in conjunction with other user devices and/or servers.

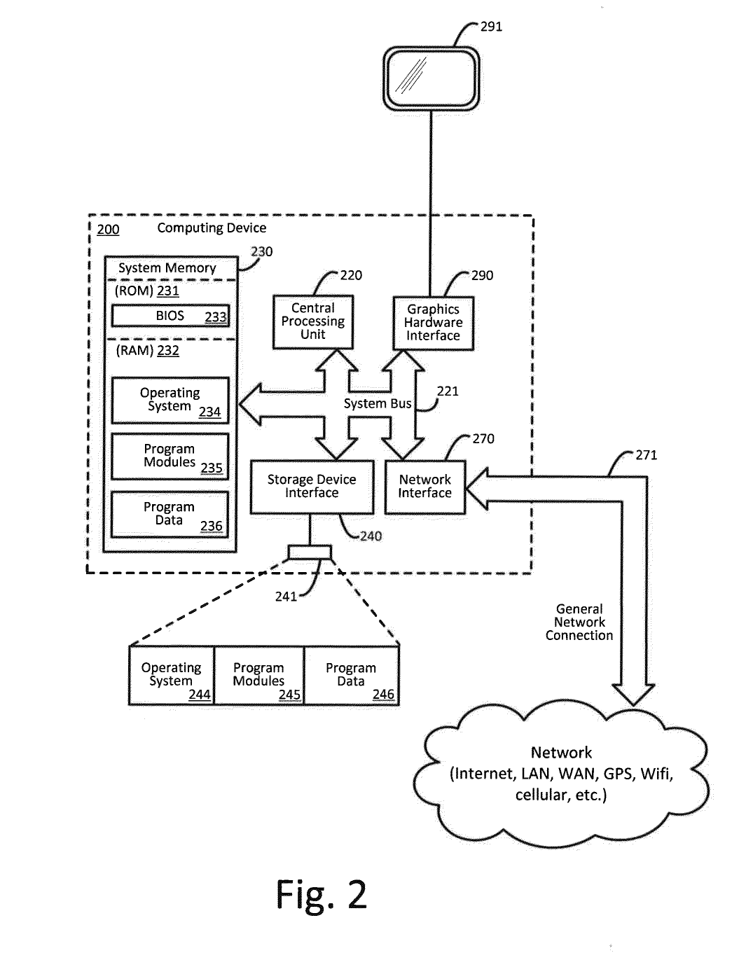

The user devices 110, 120, and the servers 130, 140, 150, 160, 170 can each be any type of computing device. Further detail regarding these computing devices of FIG. 1 is provided with reference to an exemplary computing device 200 of FIG. 2. The exemplary computing device 200 can include, but is not limited to, one or more central processing units (CPUs) 220, a system memory 230, and a system bus 221 that couples various system components including the system memory to the processing unit 220. The system bus 221 may be or include any of several types of bus structures, such as a memory bus or memory controller, a peripheral bus, and a local bus using any of a variety of bus architectures. By way of example and not limitation, one such bus architecture is the Peripheral Component Interconnect (PCI) bus. The computing device 200 includes graphics hardware, including but not limited to a graphics hardware interface 290 and a display device 291.

The computing device 200 also typically includes computer readable media, which can include any available media that can be accessed by computing device 200 and may include both volatile and nonvolatile media, and removable and non-removable media. By way of example and not limitation, computer readable media may comprise computer storage media and communication media. Computer storage media includes tangible media implemented in any technology for storage of information such as computer readable instructions, data structures, program modules or other data. Computer storage media may include, but is not limited to, RAM, ROM, flash memory or other memory technology, CD-ROM, DVD or other optical disk storage, magnetic disk storage or other magnetic storage devices, or any other tangible medium which can be used to store the desired information and which can be accessed by the computing device 200. Communication media is media that can convey computer readable instructions, data structures, or other data in a modulated data signal such as a carrier wave or other transport mechanism, including any necessary tangible information delivery hardware. By way of example and not limitation, communication media may include transceivers that send and receive signals conveyed over wired media such as a wired network or direct-wired connection, and wireless media such as radio frequency (RF) waves, infrared, and other wireless media. Combinations that include both tangible and intangible elements including any of the above may also be included within the scope of computer readable media.

The system memory 230 includes computer storage media in the form of volatile and/or nonvolatile memory such as read only memory (ROM) 231 and random access memory (RAM) 232. A basic input/output system 233 (BIOS), containing the basic routines that transfer information between elements within computing device 200, such as during start-up, is typically stored in ROM 231. RAM 232 typically contains data and/or program modules that are immediately accessible to and/or presently being operated on by processing unit 220. By way of example and not limitation, FIG. 2 illustrates operating system 234, other program modules 235, and program data 236.

The computing device 200 may also include other removable/non-removable, volatile/nonvolatile computer storage media. By way of example only, FIG. 2 illustrates a hard disk drive 241 that reads from or writes to non-removable, nonvolatile magnetic media. Other removable/non-removable, volatile/nonvolatile computer storage media that can be used with the exemplary computing device include, but are not limited to, flash memory drives, DVDs, and the like. The hard disk drive 241 and other storage media are typically connected to the system bus 221 through a non-removable storage device interface such as interface 240.

The drives and their associated computer storage media discussed above and illustrated in FIG. 2 provide storage of computer readable instructions, data structures, program modules, and other data for the computing device 200. In FIG. 2, for example, hard disk drive 241 is illustrated as storing operating system 244, other program modules 245, and program data 246. Note that these components can either be the same as or different from operating system 234, other program modules 235 and program data 236. Operating system 244, other program modules 245 and program data 246 are given different numbers here to illustrate that they are at least different copies.

Of relevance to the herein described apparatus, systems, and methods, the computing device 200 may operate in a networked environment using logical connections to one or more remote computers. For simplicity of illustration, and in conformance with the exemplary networked system 100 of FIG. 1, the computing device 200 is shown in FIG. 2 to be connected to a network. However, the computing device 200 is not limited to any particular network or networking protocols. The logical connection depicted in FIG. 2 is a general network connection 271 that can communicatively couple computing device 200 to a wired or wireless network access point such as a switch or router of a local area network (LAN) or a wide area network (WAN), or a WiFi access point, cellular base station (BS), a global positioning system (GPS) network, or one or more other wired or wireless access points or networks. The computing device 200 is coupled to the general network connection 271 through a network interface device or adapter 270 which is, in turn, connected to the system bus 221. In a networked environment, program modules that relate to the computing device 200, or portions or peripherals thereof, may be stored in the memory of one or more other computing devices that are communicatively coupled to the computing device 200 through the general network connection 271. It will be appreciated that the network connections shown are exemplary and other means of establishing a communication link between computing devices may be used.

In the herein disclosed apparatus, systems, and methods, a virtual three dimensional object is used as a single point of access to any of a predetermined collection of files. The virtual object may have a plurality of clearly delineated surfaces, any or all of which may be used to access a predetermined subset of the collection of files that contains one or more of the files. Some or all of the files may be stored in the user device, or in one or more remote locations accessible via the network, or both. As described herein, network communications may occur generally within the context of creating a virtual object, sharing the virtual object, or accessing one or more of the files linked to or otherwise corresponding to or associated with one of the clearly delineated surfaces of the virtual object. Any or all of the delineated surfaces of the object may contain thereon a select background and may also contain one or more graphical elements, such as icons or the like, each of which may be linked to one of the files. However, in a currently preferred embodiment, each delineated surface contains no more than one such icon.

In embodiments, a delineated surface of the virtual object may display an identified image or video, either alone or as a background with an icon overlaid thereon. When such an icon is selected by a user, for example using a finger on a touch-sensitive display, or using some other pointing device in conjunction with a GUI as is well known in the art, the corresponding file is accessed. The file may then be opened, for example, by obtaining the file, launching an application (app) associated with the file, and opening the file in the app. Alternatively, the file may be or comprise executable code, such as compiled or interpreted code that will execute upon the selection by the user of its corresponding icon. In either case, the app or code may be used to access a further subset of the collection of files. In an embodiment, a surface of a first cube may contain an instance of a second cube, a surface of which may itself contain an instance of a third cube, and so on in a nested structure of any desired depth.

The virtual object is implemented as a software object stored in a memory and executing on a processor, and includes data specifying parameters of the virtual object, as well as routines or methods necessary to manipulate such parameters. A virtual object is also considered to include any displayed graphical elements that may be presented in conjunction with the object on a computer display, and through which a user may interact with the virtual object. For example, the display representation of a virtual object may include one or more associated graphical elements, which may optionally be implemented as separate user interface objects associated with the virtual object, such as to control physical manipulation of the virtual object, or to invoke functionality applicable to the entirety of the virtual object, such as sharing it with another user device, as will be described. In an embodiment, a group of four buttons in the shape of arrows or the like, one each pointing up, down, left, and right, may be displayed in conjunction with the virtual object and used to turn, spin, or otherwise manipulate rotation or orientation of the virtual object on the display. Other graphical elements may also be associated with the virtual object to gain access to properties of the virtual object, or to invoke functions associated with the virtual object. Moreover, certain aspects of a virtual object, such as edges or vertices at which two or more of the surfaces meet, may have associated with them object manipulation or other functionality. For example, dragging an edge or vertex of the virtual object may spin the virtual object in the direction a tangible object would spin if similarly handled, with or without the effect of slowing friction, or may turn the virtual object to just its next available surface. However, other display representations may be used in the alternative, and the invention is not limited to the particular exemplary virtual objects, controls, and feature embodiments described hereinafter.

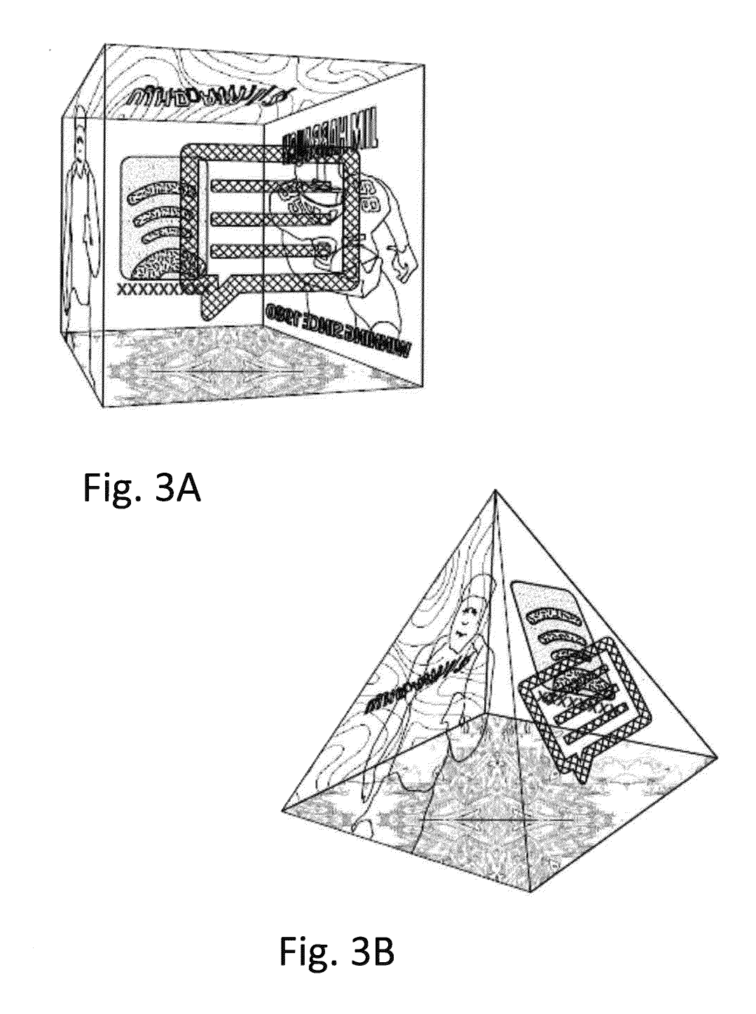

Referring now to FIG. 3A, an exemplary virtual three dimensional object 300 is shown, in this case, a polyhedron. In the exemplary implementation illustrated, the polyhedron is a cube, but could alternatively be a different polyhedron, such as a tetrahedron as in FIG. 3B, or an octahedron, dodecahedron, or icosahedron (that is, a regular, convex polyhedron with congruent faces of regular polygons with the same number of faces meeting at each vertex). Alternatively, any other virtual object may be rendered and presented, provided it comprises clearly delineated surfaces, which may include flat or curved faces and straight or curved edges, with at least one surface viewable in the foreground of a perspective of the virtual object presented on a display device.

One or more of the surfaces of the virtual object, such as each face of the cube shown in FIG. 3A, may be rendered as semitransparent to any desired degree, so that features of surfaces behind the foreground surface may be seen. Further, graphical features disposed on a surface may similarly be rendered as semitransparent to any desired degree. Alternatively, a surface, or a portion of or feature disposed on a surface, may be rendered as opaque, semitransparent to any desired degree, or transparent. As shown in FIG. 3A, the cube is rendered as a wireframe object, and the face in the foreground is transparent except for a graphical element disposed thereon, which is semitransparent. The other faces of the cube are similarly rendered, although the different surfaces of a virtual object need not be rendered in the same manner. That is, one face may be opaque, another semitransparent, another transparent with semitransparent graphical elements, etc. Graphical elements disposed on the surfaces may be similarly individually rendered differently. In an embodiment, every surface of an object and every graphical element disposed thereon may be rendered with the same opacity characteristics, which may be determined by default, or may be set as desired by a user.

As shown in FIG. 3A, the front and back surfaces of the exemplary cube each comprise a single (semitransparent) graphical element disposed on a transparent background. The background of a surface may alternatively comprise an image, as shown on the left and right faces of the cube of FIG. 3A, or a design as shown on the top and bottom faces of the cube. Or, the background of a surface may rendered as having a color. In embodiments, one or more of the surfaces may comprise more than one such element. Some or all of these features may have a default configuration, and/or may be modified by a user when designing the cube, as will be described. Similar features are also shown in the tetrahedron of FIG. 3B.

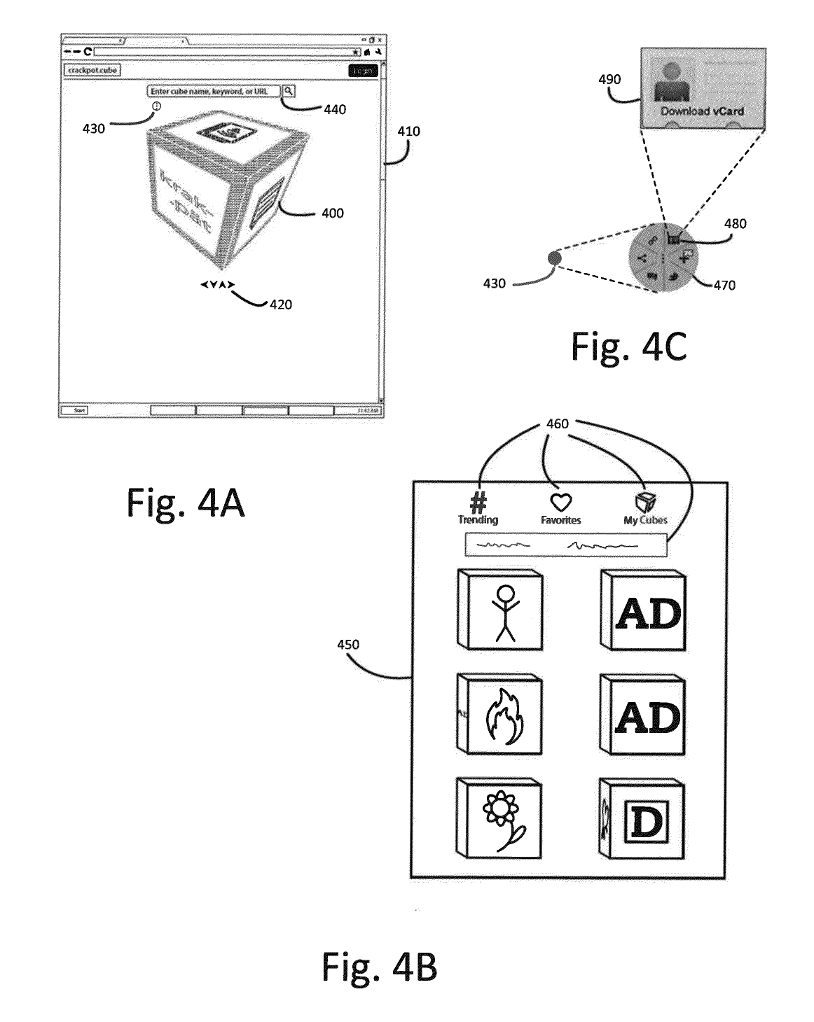

A cube may be presented in a number of different ways. For example, FIG. 4A shows a single cube 400 appearing in a web browser window 410. In such an implementation, the various features of the cube and the files and apps that may be accessed thereby may take advantage of web-based technologies such as browser plugins, Internet communication protocols, HTML links, and the like. As shown, four pointers 420 are included under the cube for a user to rotate or flip the cube in the direction indicated by a selected pointer. In addition, graphical element 430 is also associated with the cube, and may be included to provide access to commonly used functionality that is applicable to the cube as a whole. Such functionality may include, for example, sharing the cube via a social media sits such as Facebook® or Twitter®, or as an attachment to a text message or an email, or by automatically generated code that may be inserted into a user's web page. Other functionality may include visiting a predetermined website, downloading a predetermined vCard containing information of a person or business, or some other function. FIG. 4C shows an exemplary implementation of element 430 in isolation, in which selecting element 430 causes the element to transition to a larger version 470. The larger version comprises a plurality of sections, any of which may have disposed therein an icon. By selecting an icon, the user may invoke the corresponding functionality. Here, icon 480 can be selected to display a vCard 490 containing information pertaining to a business or person associated with the subject matter of the cube. The vCard may then be downloaded, or an email sent to an email address on the card, or the like.

Further, a search box 440 may be included, for example, to search for other cubes that are not shown but may be available to the user, either residing locally on the user computing device or residing remotely on a server or the like communicatively coupled to the user device. Illustratively, the search results may include links to other available cubes that pertain in some way to the search term. If a link is selected, the corresponding cube may be accessed and displayed, for example, by opening a new tab in the browser, or by replacing the currently presented cube with the one selected.

FIG. 4B shows a different exemplary implementation in which a plurality of cubes are presented on a “desktop” of a display 450, similar to the manner in which conventional icons are presented on a desktop of a computing device running a Windows® OS or the like. As shown, exemplary embodiments of the objects may be different and representative of different collections of files, such as each of the cubes on the left side of the display, or a plurality of instances of the same object may be representative of the same or similar collections of files, such as the two cubes showing “AD” on their front faces. FIG. 4B also provides interface elements 460 that provide functionality pertaining to virtual objects in general. For example, the elements 460 shown in FIG. 4B, designated as “Trending”, “Favorites”, and “My Cubes”, may invoke information pertaining to a plurality of virtual objects, which information may be updated dynamically.

In an embodiment, each of the cubes shown in FIG. 4B may be manipulated individually. Alternatively, the selection of a cube may enlarge the selected cube and overlay it on the displayed contents or replace the displayed contents entirely. In an embodiment, such a selected cube may retain a focus of the user interface until it is dismissed, for example, by a user selecting an interface element to restore the screen to its previous condition (not shown).

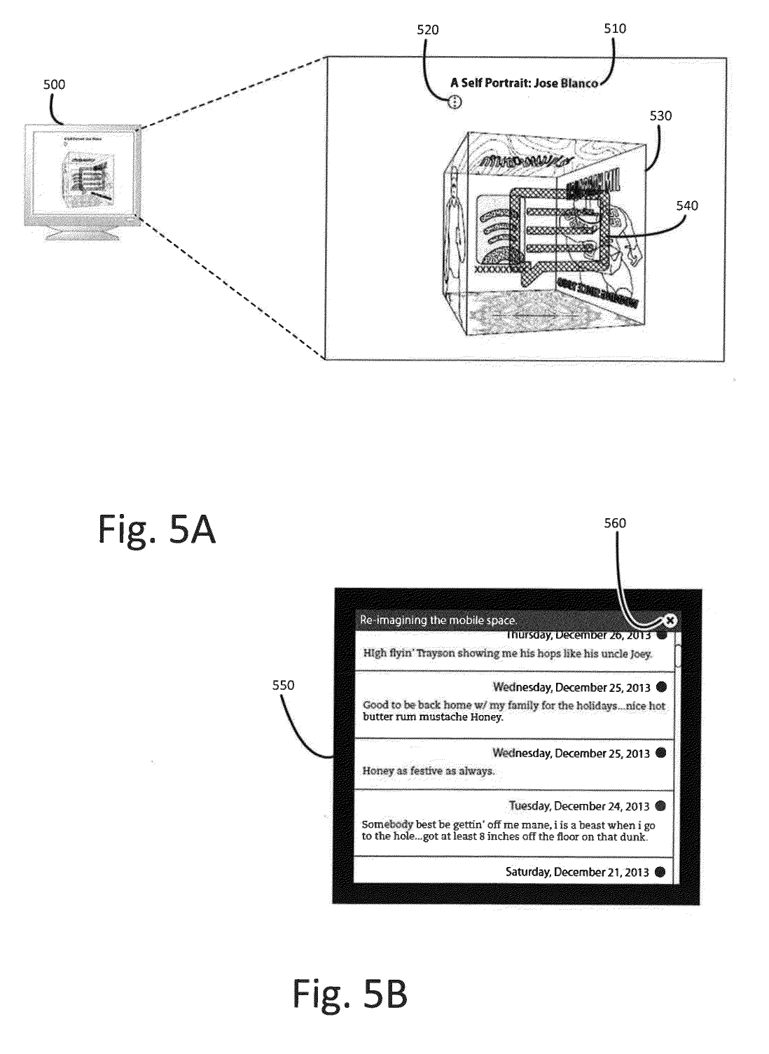

Referring now to FIG. 5A, a single cube is shown presented on a display of a user device 500. A title 510 is displayed with the cube, and a graphical element 520 is displayed under the title that may be selected by a user to invoke one or more functions related to the cube as previously described, such as sharing the cube. The cube has disposed on the surface most in the foreground 530 a single graphical element 540. Choosing the graphical element may retrieve a file, invoke an action, or the like. As shown in FIG. 5A, the graphical element is in the form of a callout, and in this case selecting the callout launches an app, here, the blog app 550 shown in FIG. 5B. In embodiments, such a launched app may be a pre-existing app that is accessed through a presented interface. For example, a frame may be presented that presents within its borders a web-based blog such as a Wordpress blog (not shown), for example. Alternatively as shown in FIG. 5B, an instance of a blog app may be launched. In an implementation, the frame or app may be overlaid on the previously presented screen, which may be dimmed to focus a user's attention on the app. The app may have the focus of the user interface until it is dismissed by the user, for example, by selecting an icon 550 provided for that purpose.

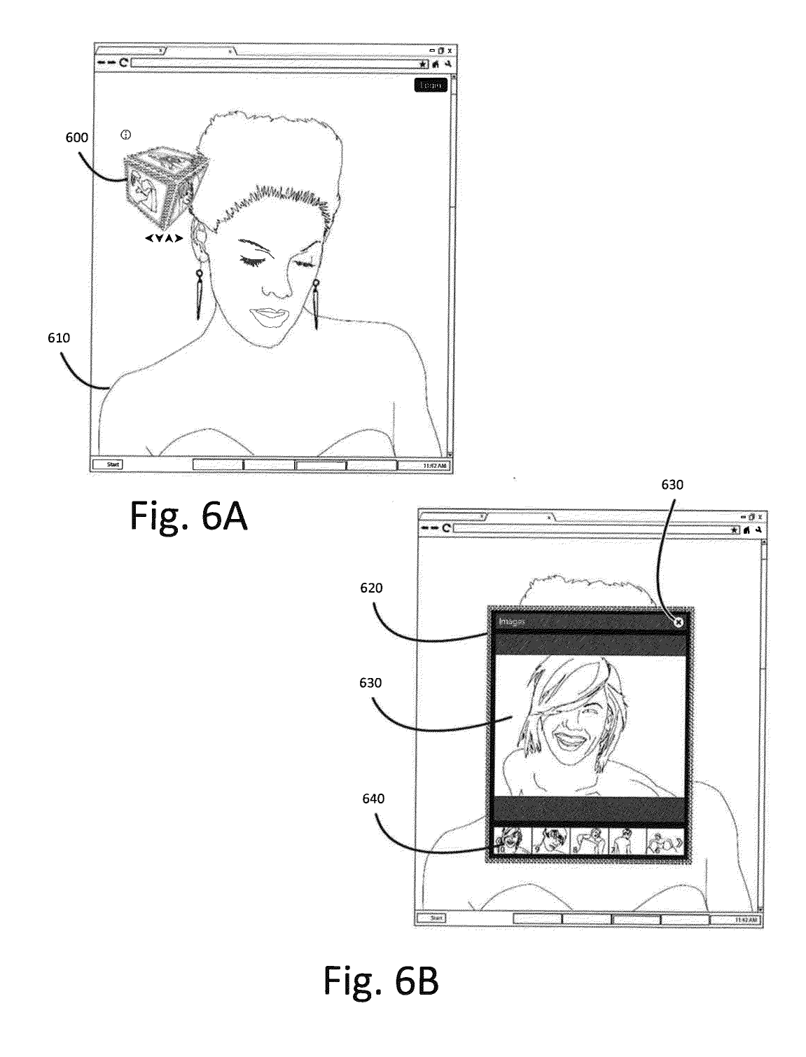

FIG. 6A shows another exemplary illustration of a virtual object, 600 associated with interface elements for navigation (pointers below the cube) and for invoking functionality pertaining to the cube (above the top left of the cube). Here, the virtual object is shown contained in a web page with an image 610 displayed in the background, which may be a static or a moving image. The web browser may have been invoked and the web page presented on a user device, for example, responsive to the user selecting a link contained on a surface of a different virtual object presented on the device. In such an example, the background image may pertain to the subject matter of the files made accessible via the cube. Here, by proper manipulation of the cube by a user to bring a desired particular surface to the foreground, and then selecting a desired particular icon or the like disposed on that surface, the app shown in FIG. 6B may be launched. As illustrated, the app may run in a frame overlaid on the background, with the cube no longer visible. Subsequently choosing the “dismiss” icon 630 causes the frame to disappear and the cube to reappear. The app in this case is an image viewing app, containing a main viewing area 640 and a scrollable palate of available images 650. As shown, the displayed image is image number 10 of a series of images, although other viewing app arrangements may be implemented.

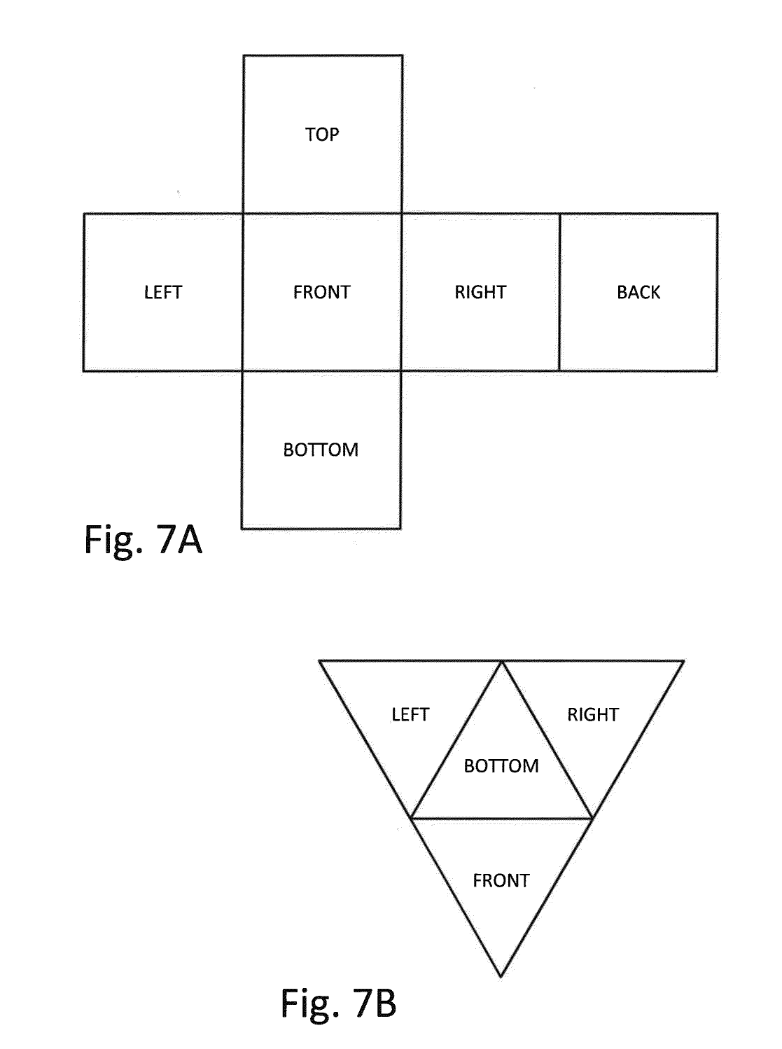

In a currently preferred embodiment, a computer-implemented virtual object-building platform may be provided with which a user may set up a virtual object. The user may select a particular type of object to implement from a plurality of choices. The user may then select each surface of the object in turn to set the properties of each surface. FIG. 7A illustrates surfaces of an object that is a cube, while FIG. 7B illustrates surfaces that will form a tetrahedron.

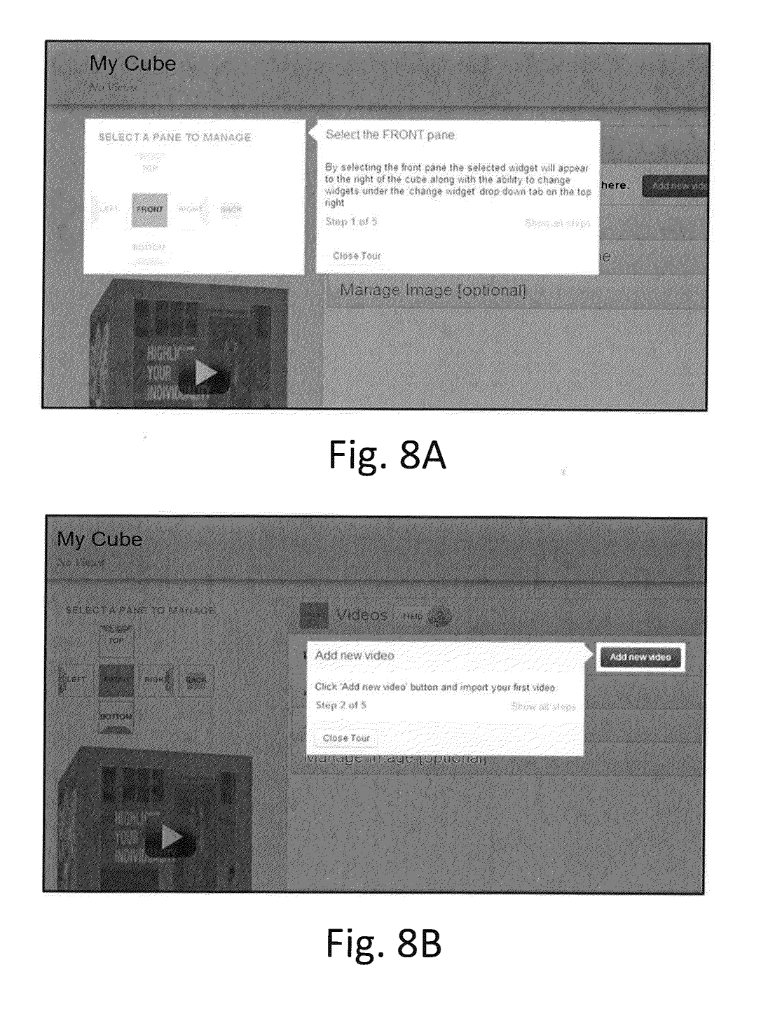

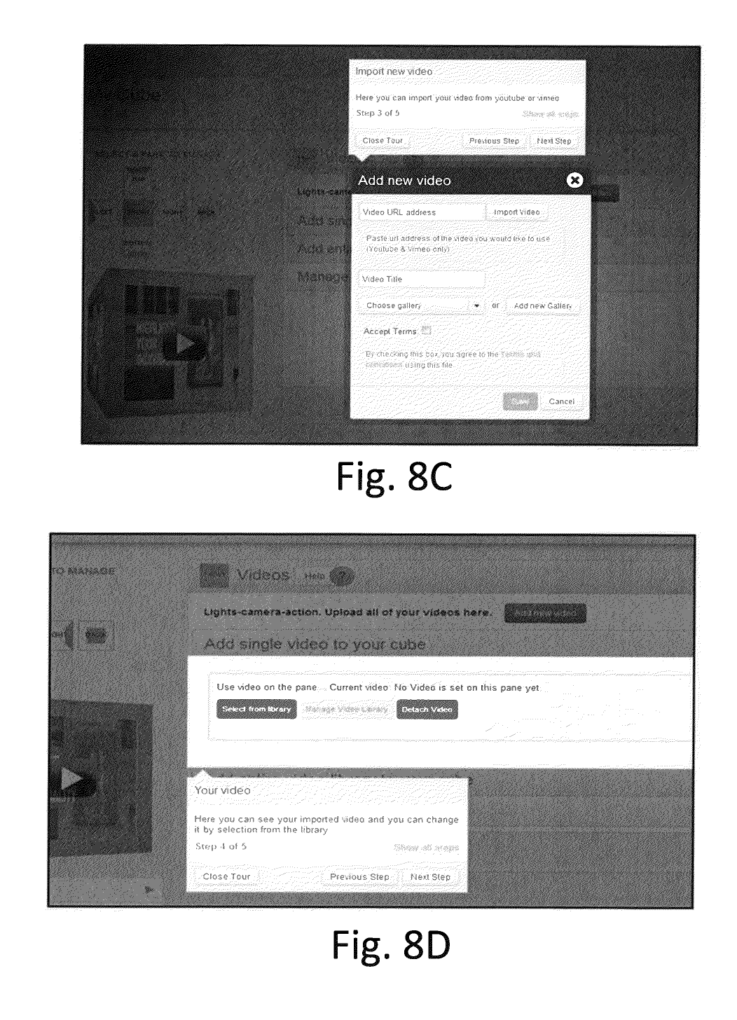

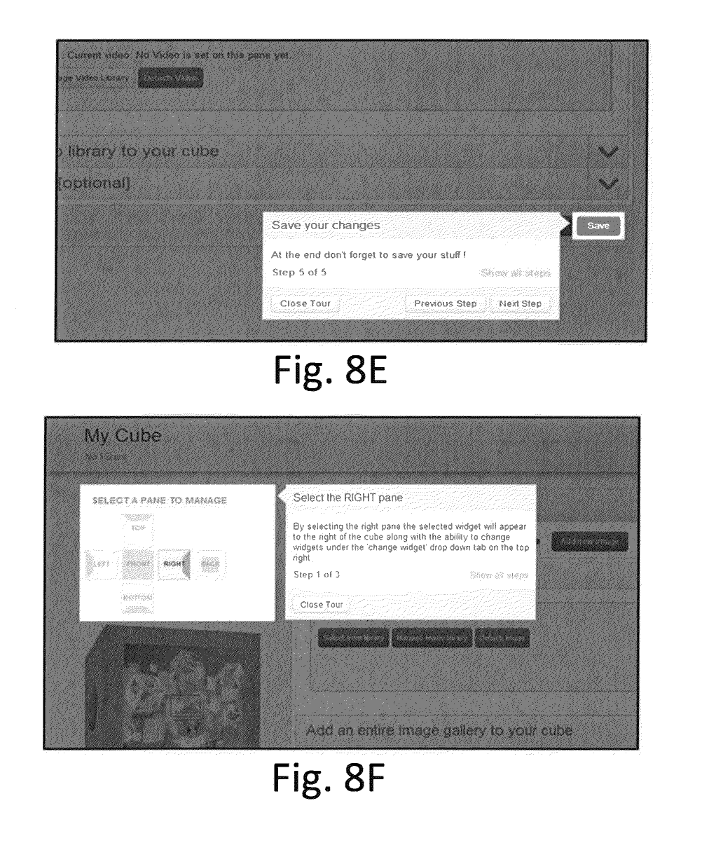

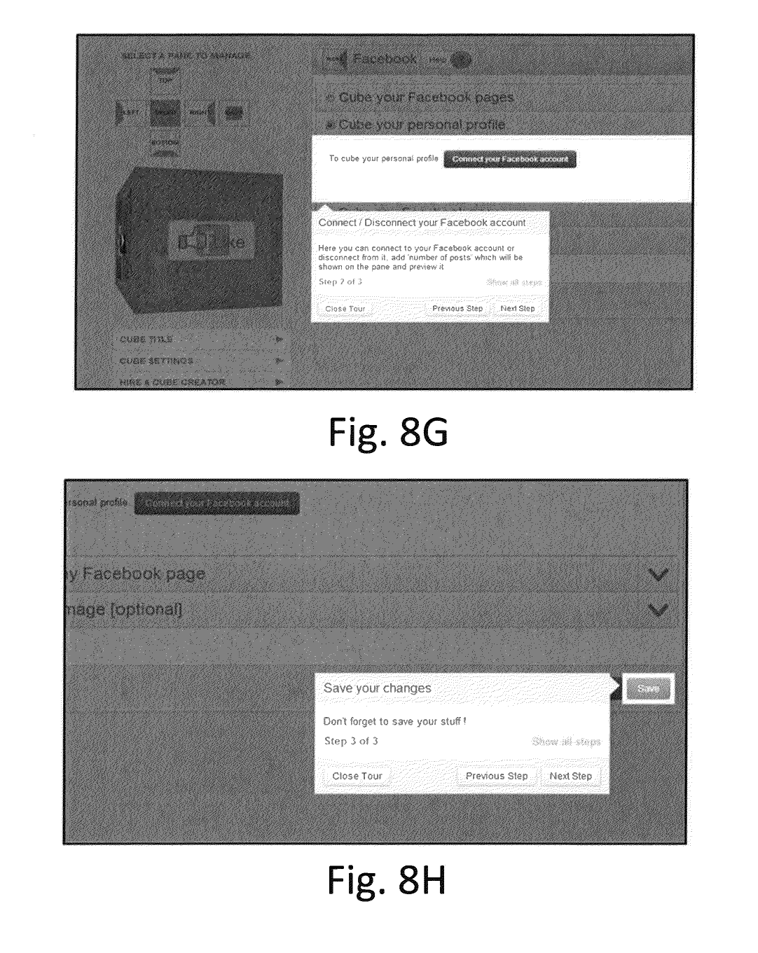

The object-building platform preferably provides screens with tutorial features and a design flow that facilitates setting up a virtual object by a user. For example, FIGS. 8A-8H show illustrative screenshots of an exemplary implementation for setting up a virtual cube. FIGS. 8A-8E illustrate a tutorial showing a user how to add a link to a video to a surface of an exemplary cube. FIGS. 8F-8H illustrate a tutorial showing a user how to add an icon to a surface of the cube to invoke the user's Facebook® account. Other similar tutorials and screens (not shown) can teach and lead a user through each step of setting up every user-selectable aspect of a virtual object by a user.

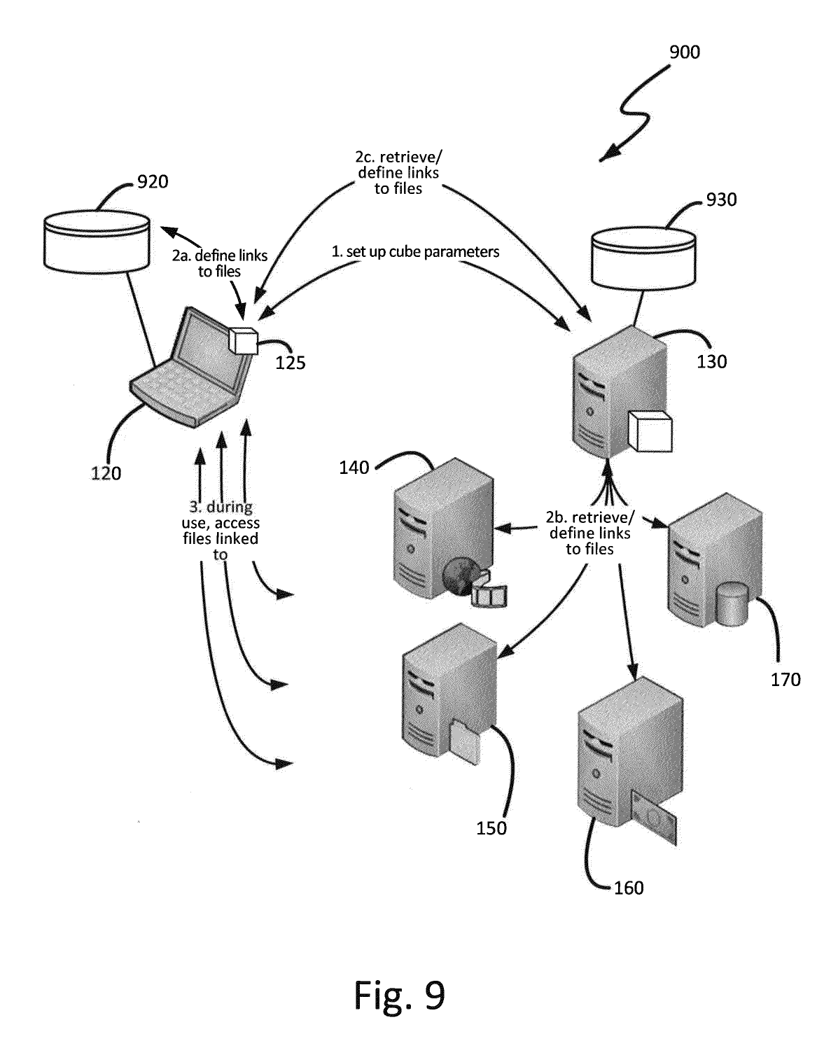

FIG. 9 illustrates the interaction of different parts of an exemplary system 900 in setting up a virtual object, including system components introduced in FIG. 1. As shown, user device 120 with local storage device 920 is being used to set up a virtual cube 125. The local storage device may store various files that the user is making accessible through the use of the cube being set up. Upon completion of the cube, local storage 920 will also store therein all of the data required to implement the cube, such as the user-selected cube parameters, the links to the set and subsets of files that may be accessed using the cube, and the like. Server 130 with server storage 930 provides computer instructions and other resources needed for the operation of cube 125 while being built, as well as during operation. Servers 140, 150, 160, and 170 provide data and functionality to the cube associated with streaming media, general files, e-commerce, and data from databases and relevant data relationships and structures, respectively.

As shown in FIG. 9, in step 1 the user sets up the parameters that will define the various aspects of the cube, for example, by using series of screens such as those in FIGS. 8A-8H. In steps 2a-2c, links to files that will be accessible via the cube are established. In step 2a, links to files stored locally in storage 920 are set up. In step 2b, files that reside on servers are identified, either directly by user device 120 over the network, or indirectly with server 130 acting as intermediary between the user device and other servers on the network. If server 130 is acting as an intermediary, then server 130 may define the links to the files, and in step 2c the links to the remote files may be provided by server 130 to user device 120 for inclusion in cube 125. After the cube is set up with the links to the collection of files, and during its operation as a user is interacting with the cube, files, instructions, and other information stored locally in storage 920 can be accessed directly or through links to the local files. Files, instructions, and other information that remains stored remotely in servers 130-170 can be accessed over the network using links to the remote files.

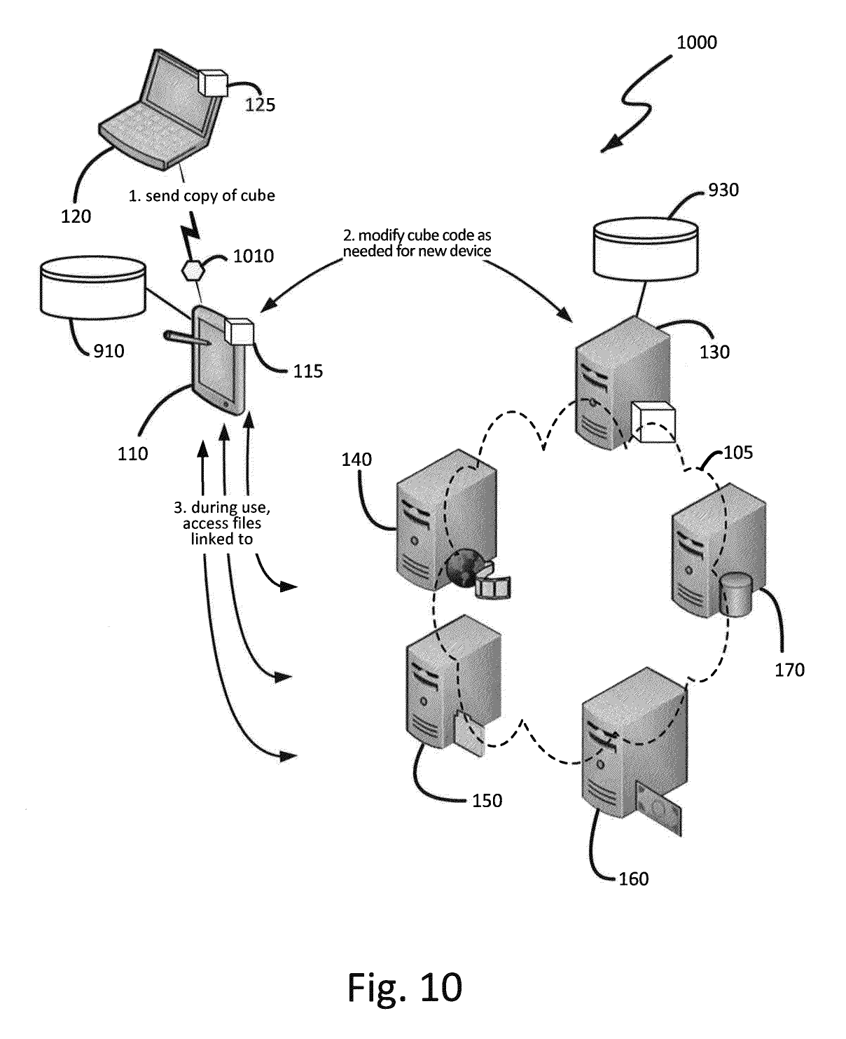

FIG. 10 illustrates sharing a cube with another user device. As shown, in step 1 user device 120 sends a copy of a preformed (already set-up) cube to user device 110. The copy may be sent directly, for example using a Bluetooth, near-field communications (NFC), or other direct communication channel between the user devices. Alternatively, the cube may be sent as an attachment to an email, text message, or the like from one user device to another. In either case, in addition to the links to the remote files, user device 120 must also provide copies of any local files that may be needed by the cube to operate properly. Preferably, the cube and the file copies may be grouped in a single self-installable data object 1010. When such a data object is received by device 110, it may self-install by depositing the file copies in local storage 910 using the same file paths that were used in local storage 920, or the files may be stored in a different logical location within the file structure of storage 910, and new links to those files generated and incorporated into the cube to replace the corresponding original files. When the cube is received and presented on the display of user device 110, it can be used in the same way as on device 120.

In an embodiment as shown in step 2, before providing the cube copy to device 110, the data object 1010 may communicate with cube server 130, and provide any information regarding device 110 that may influence how the cube may be implemented thereon. For example, if user device 120 is a laptop computer with a Windows® OS, and device 110 is a tablet computer with an Adroid® OS, at least some of the code or other resources used in the cube may need to be modified to work properly on the tablet. The data object 1010 may detect that device 120 and device 110 are different in a way that indicates the cube should be modified for operation on device 110. Accordingly, data object 1010 may instruct user device 110 to communicate with server 130 in order to modify the cube, such as by the server providing to the user device any code or other resources needed by device 110 for the cube to operate properly, and the cube thereafter being modified by the user device. Alternatively, the user device may provide information needed by the server to modify the cube, which the server thereafter modifies and provides the modified cube to device 110. Or, the user device 110 and the server 130 may otherwise cooperate to modify the cube as needed for operation on the user device. Finally in step 3, on user device 110 the cube operates as on user device 120, accessing local files, and remote files over the network 105 (shown as a dotted line) as before.

In an embodiment, a cube may contain attributes that limit its functionality to certain parameters selected by a user. For example, a certain location may be chosen, such as by inputting geographic positioning coordinates such as latitude, longitude, and/or altitude, or by using a present location as indicated by a GPS or other location system. Further, a certain radius from that location may be used to define a predetermined area, or alternatively a geofence may be defined that contains a predetermined area, and the cube may be configured to be operable only within, or outside of, that area. Alternatively or in addition, the cube may be configured to be operable only after or before a predetermined time, or within a predetermined window of time, and/or for a predetermined duration. Further, the cube or an associated resource may be configured to monitor one or more other user devices, and the cube and/or an associated network resource may be configured to share the cube, such as by sending a copy of the cube to one or more of those users' devices, and/or to other devices, upon the meeting of one or more predetermined conditions that are met by the users' devices. Moreover, rules of operation may be set up for a virtual object that refer to these and/or other physical conditions or criteria, such as a temperature at a certain location or area, a speed, direction, and/or acceleration of movement of one or more user devices, and the like.

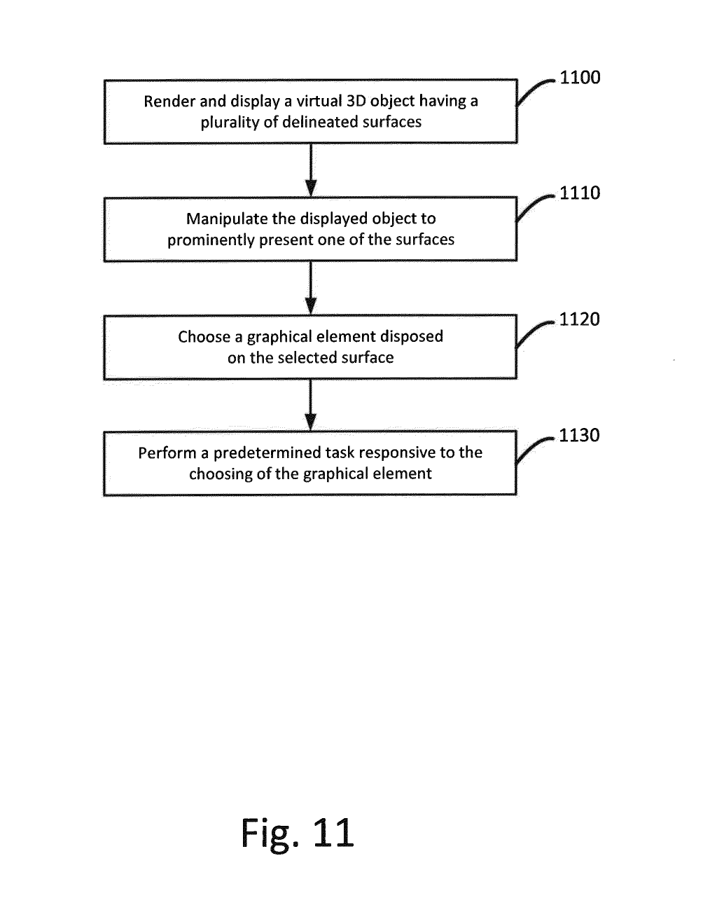

FIG. 11 is a flow diagram of a method of operation in accordance with the disclosure. In step 1100, a virtual 3D object with a plurality of delineated surfaces is rendered and displayed on a user device. A user may then manipulate the displayed object to prominently present one of the surfaces, 1110. A graphical element disposed on that surface may then be chosen by a user, 1120. Responsive to the choosing, a predetermined task may be performed by the user device in association with the virtual object, 1130.

Features and functions that may be implemented in exemplary embodiments of the herein described apparatus, systems, and methods, will now be described. The present invention may provide for the simultaneous providing of myriad information, myriad content types, the limiting of information distribution, and improved relevancy of provided information, through the use of a virtual three dimensional object, such as the cube previously described and illustrated. Information and/or content may be posted to the cube, and may be given a time, type and/or location stamp, and may be accessible by at least one other user according to at least one set of rules.

The cube allows for an improved use of “on-screen real estate,” such as to allow improved user focus on a small screen, such as the screen of a mobile device. Particularly in a mobile environment, the user's at least one focus point may be on the cube as a whole (or the shape presented), for example, and the myriad of information/content available on the various faces thereof.

A user may have access to one cube or a plurality of cubes. For example, one or more cubes may be associated with a user account, such as an account hosted on the cube server 130, and as such may be selected, designed, or otherwise provided by the user. That is, the user may select content and/or features for association with a cube, or, more particularly, with individual faces of the cube. Further, the user may have access to one or more cubes designed or otherwise provided by another. For example, one or more cubes associated with a third party, such as on a social network site, may be accessible to a fan, friend, associate, linked person, or the like.

Accordingly, the cube may also have at least one social network aspect and may allow for the aggregation and or presentation of one or more social networking channels. The accessing of an existing social network may provide the user with full and/or abbreviated access/presentation of the desired social network site, such as dependent on user rules. For example, access to a Facebook account may be limited to a portion of the Facebook information feed available and may thus be accessible on one side of a cube. In this way, for example, a user may limit the amount of viewed information to make more manageable the viewing of wanted versus unwanted information. For example, the user may block various side banner ads, picture streams and other disparate information feeds.

A cube may comprise a plurality, such as six (6), faces, and content and/or features may be provided on each face of the cube. In exemplary embodiments, a virtual object may have any number of faces of various sizes and shapes so as to accommodate a desired number of faces. By way of non-limiting example, a virtual object may form a pyramid with triangular faces and a bottom. For example, the object may be in the form of a regular tetrahedron comprising four equilateral triangles meeting at their edges, and three of which join at each of four vertices. Alternatively, six (6) triangular faces may be joined at a single point at one point common to all of the plurality of triangular faces, and joined at a hexagonal face at the leg of each triangular face opposite the commonly-joined point.

The faces of the cube may be simultaneously viewable by a user, for example, by surfaces in the foreground being translucent, irrespective of which face(s) is (are) directly within view of the user. Additionally and alternatively, content associated with faces oblique to the user's direct view may be rendered as ghosted, transparent, opaque, underplayed (with the direct view face overlayed, and hence more significantly visible), represented iconographically (i.e., an arrow represents a video, a note represents music), or the like.

The user may preferably be enabled to graphically “rotate,” or otherwise “move,” the faces of the cube into direct view, such as using a finger, pointer, cursor, or the like. Such rotation may be limited (such as only in the x axis, or only in the y axis, or only in the x and y axes) or unlimited (such as free rotation through the x, y and z axes). The rotation may comprise an initial “grab” by the user, such as by a user indication using a mouse cursor, finger, or the like, followed by a user indication of movement. For example, the greater the extent of the user movement in a given direction, the greater the graphical rotation in that direction, and through the faces, which may occur. Alternatively, a user movement in a given direction may indicate a rotation only to the next available face following rotation in the indicated direction. Similarly, the extent of rotation in any given may be dictated by the speed of the user's indication in that direction—that is, a faster user movement may dictate a greater rotation. Likewise, a user may provide a movement or rotation indication using provided graphical user controls, such as directional on-screen arrows or the like.

The user may access the content indicated by a given face by accessing that face. For example, a particular face may be rotated into an at least partial view and, more preferably, into a direct view. Thereafter, the user may “release” the cube from the aforementioned “grab” and consequent rotation indication, and may indicate an access request. The access request may comprise a user indication to access the content associated with the accessed cube face.

Content access may include, for example, the graphical providing of the accessed content in an exploded window. In a preferred embodiment, the provided content at least partially includes the content indicated on the accessed face. Moreover, the type of content may be that indicated by the iconography associated with the accessed face.

In order to provide the accessed content, and the aforementioned graphical cube behavior, the cube may ping the user's device to identify the operating system being employed. Thereby, only the cube or cube features that are compatible with the identified operating system may be provided. Compatible cube code may be resident local to the user's interaction and/or may be provided remotely, and, irrespective of the location of the compatible cube code, the compatibility assessment may be made locally or remotely, and may be made upon first use of an identifiable device, or may be made upon each instantiation of cube access.

Although the invention has been described and illustrated in exemplary forms with a certain degree of particularity, it is noted that the description and illustrations have been made by way of example only. Numerous changes in the details of construction, combination, and arrangement of elements and steps may be made. Accordingly, such changes are intended to be included within the scope of the disclosure, the protected scope of which is defined by the claims.

What is claimed is:

1. A tangible computer-readable medium storing computer-executable instructions for organizing a plurality of files, wherein the computer-executable instructions, when executed on a user device, cause the user device to perform steps comprising:
rendering and presenting on a display of the user device a virtual three dimensional object having a plurality of delineated surfaces;
receiving a user input by the user device to manipulate the virtual object to present a select one of the surfaces more prominently on the display than the non-selected surfaces of the virtual object;
receiving a user input by the user computing device as a choosing of a graphical element disposed on the selected surface, and
performing a predetermined task responsive to the choosing of the graphical element.

2. The computer-readable medium of claim 1, wherein the virtual object is a virtual cube.

3. The computer-readable medium of claim 2, wherein the selected face is a square face of the cube presented in the foreground.

4. The computer-readable medium of claim 3, wherein the selected face has disposed thereon at least one graphical element linked to a file or to executable code.

5. The computer-readable medium of claim 4, wherein the graphical element is linked to a file with a name containing a file extension that, when the graphical element is chosen by a user, is used to launch a predetermined application (app) and open the file.

6. The computer-readable medium of claim 4, wherein the graphical element is linked to computer code that is executed responsive to the graphical element being chosen by a user.

7. The computer-readable medium of claim 4, wherein the file or computer code is stored on the user device.

8. The computer-readable medium of claim 4, wherein the file or computer code is stored remotely from the user device and is accessed by the user device over a network.

9. A user interface enabling a user to create a virtual three dimensional object for organizing a plurality of files, the interface comprising:
a first input mechanism for accepting user input for setting at least one characteristic of a virtual three dimensional object having a plurality of delineated surfaces;
a second input mechanism for accepting user input for choosing at least one graphical element for placement on at least a select one of the delineated surfaces, and
a third input mechanism for accepting user input for setting at least one characteristic of the graphical element placed on the select surface.

10. The user interface of claim 9 wherein the first input mechanism is for choosing one of a plurality of available three dimensional shapes.

11. The user interface of claim 10, wherein the chosen shape is a cube.

12. The user interface of claim 9, wherein the graphical elements include a plurality of elements, each of which is one of an image, a design, and an icon.

13. The user interface of claim 9, wherein the characteristic of the graphical element placed on the select surface includes a link to a file or executable code.

14. A computing device with an associated display device on which is presented a virtual three dimensional object for organizing a plurality of files, said-computing device comprising:
a tangible computing processor;
a network interface communicatively coupled to the processor and operative to communicatively couple the processor to a tangible data communication network; and
a non-transitory computer-readable data storage device communicatively coupled to the processor and having stored thereon computer readable instructions which, when executed by the processor, cause the computer to perform steps including:
presenting a virtual three dimensional object on the display device, the object comprising a plurality of delineated surfaces;
manipulating, responsive to a user input, the virtual object to present one of the surfaces more prominently than the others as a selecting of one of the surfaces;
receiving a user input as a choosing of a graphical element disposed on the selected surface, and
performing a predetermined task responsive to the choosing of the graphical element.

15. The computing device of claim 14, wherein the virtual object is a virtual cube.

16. The computing device of claim 15, wherein the selected face is a square face of the cube presented in the foreground.

17. The computing device of claim 16, wherein the selected face has disposed thereon at least one graphical element linked to a file or to executable code.

18. The computing device of claim 17, wherein the graphical element is linked to a file with a name containing a file extension that, when the graphical element is chosen by a user, is used to launch a predetermined application (app) and open the file.

19. The computing device of claim 17, wherein the graphical element is linked to computer code that is executed responsive to the graphical element being chosen by a user.

20. The computing device of claim 17, wherein the file or computer code is stored on the user device.

21. The computing device of claim 17, wherein the file or computer code is stored remotely from the user device and is accessed by the user device over a network.
